(19) United States
(12) Patent Application Publication
(10) Pub. No.: US 2024/0417155 A1
(43) Pub. Date: Dec. 19, 2024

(54) FRESH-KEEPING VACUUM BOTTLE WITH TWO COMPARTMENTS

(71) Applicant: ZHEJIANG UKPACK PACKAGING CO., LTD, Yuyao City (CN)

(72) Inventors: Shunjin JI, Yuyao City (CN); Da XU, Yuyao City (CN)

(73) Assignee: ZHEJIANG UKPACK PACKAGING CO., LTD, Yuyao City (CN)

(21) Appl. No.: 18/657,913

(22) Filed: May 8, 2024

(30) Foreign Application Priority Data
Jun. 19, 2023 (CN) 202310729384.X

(51) Int. Cl. B65D 83/06; B05B 11/10; B65D 81/32

(52) U.S. Cl. CPC B65D 83/06; B05B 11/1047; B05B 11/1081; B65D 81/3211; B65D 2205/02

(57) ABSTRACT

A fresh-keeping vacuum bottle with two compartments for preserving freshness, specifically designed to tackle the technical challenges faced by existing similar products in packaging powder products like freeze-dried powder, for example, prone to moisture, and challenged to reuse and assemble as replacement bottles. The bottle mouth of the vacuum bottle body and the large circle are connected through snap fitting to create a lower liquid storage compartment. The large circle includes a fixed large circle, a rotating large circle, and an inner sleeve large circle, with the fixed large circle being connected through snap fitting to the mouth fixed on the bottle body. The rotating large circle rotates the sealing plug until the upper thru-hole of the rotating large circle, the middle thru-hole of the sealing plug, and the lower thru-hole of the fixed large circle are aligned sequentially to achieve dual-compartment mixing.

### TECHNICAL FIELD

The present invention relates to a vacuum bottle, or specifically, a fresh-keeping vacuum bottle with two compartments.

### BACKGROUND ART

Vacuum bottle is a kind of container used to isolate the gas from the outside temperature or to isolate the cosmetic container from the outside bacteria, which generally comprises of a cylindrical container and a piston placed at the bottom. In order to facilitate the mixing of two liquids or powders in the vacuum bottle, some vacuum bottles adopt liquid mixing mode by engaging two sets of bottles, while other bottles have two compartments set in the vacuum bottle, as disclosed in the Chinese patent document under the application Ser. No. 20/222,0231955.8, the date of authorization: 1 Jul. 2022, the utility model patent entitled “A rotary double-liquid mixing vacuum bottle”; as disclosed in the Chinese patent document under the application Ser. No. 20/202,1667654.7, the date of authorization: 1 Jun. 2021, the utility model patent entitled “A double-compartment vacuum mixing cosmetic packaging container”; as disclosed in the Chinese patent document under the application Ser. No. 20/201,1237088.0, the date of authorization: 29 Jan. 2021, the utility model patent entitled “A vacuum bottle with two compartments”; as disclosed in the Chinese patent document under the application Ser. No. 20/152,0299856.3, the date of authorization: 9 Sep. 2015, the utility model patent entitled “A double-compartment mixing vacuum bottle”; the above products and similar products generally adopt the way of setting up the inner cavity at the inner diameter of the bottle mouth, and cause the opening of the inner cavity by pressing the head cap to drive the valve stem to move to the inside of the bottle, i.e., pressing the pump head and opening the top of the pump head; however, it is less likely to use the thru-hole of the rotating large circle of openings above the bottle mouth to drop the material into the bottle. This structural design makes it susceptible to moisture, making it more challenging to package lyophilized powder products. Additionally, the internal and external bottle structure is less used, and the inner bottle is not extensively designed with functional replacement devices for repeated and assembled use.

### SUMMARY OF THE INVENTION

In order to overcome the above deficiencies, the object of the present invention is to provide a fresh-keeping vacuum bottle with two compartments in the field, so that it can solve the technical problems of the existing similar products that are difficult to be used for packaging lyophilized powder and other powder products, which are susceptible to moisture, and are difficult to be used as a replacement for reuse and assembly use. This object is attained by the following technical solutions.

A fresh-keeping vacuum bottle with two compartments, comprising a piston inside the bottle body, a vent hole disposed on the bottom side of the bottle body. The mouth of the bottle body is connected to a large circle through snap fitting, thus creating a lower liquid storage cavity. The liquid compartment is connected to the head cap through the valve stem of the pump core assembly, in which the valve stem extends out in a large circle; wherein the said large circle comprises a fixed large circle, a rotating large circle, and an inner sleeve large circle. The fixed large circle is attached to the mouth of the bottle body through snap fitting, a gasket is provided at the joint, a lower thru-hole is provided on the side of the fixed large circle at the mouth above the lower liquid storage cavity in the bottle body, an upper thru-hole is provided on the side of the rotating large circle corresponding to the lower thru-hole; a sealing plug is disposed on the fitting face where the rotating large circle is fastened and attached to the fixed large circle, the said sealing plug is affixed to the bottom of the rotating large circle, the middle thru-hole of the sealing plug aligns with the upper thru-hole of the rotating large circle. The circle rim at the bottom of the inner sleeve large circle is fastened and attached to the circle rim inner diameter on the top of the rotating large circle. The pump core assembly is fastened and attached to the large circle of the inner sleeve large circle or the rotating large circle, with the pump body outer diameter hermetically fit to the fixed large circle, rotating large circle, and inner sleeve large circle. An upper liquid storage cavity is formed between the top groove of the rotating large circle and the bottom groove of the inner sleeve large circle. When the rotating large circle drives the sealing plug to rotate towards a certain position, making the upper thru-hole of the rotating large circle, the middle thru-hole of the sealing plug, and the lower thru-hole of the fixed large circle aligned sequentially, the material stored in the upper storage cavity falls into the bottle body until it mixes with the liquid stored in the body. Gripping the fixed large circle and rotating it to align the upper thru-hole of the rotating large circle in the upper storage cavity and the middle thru-hole of the sealing plug with the lower thru-hole of the lower fixed large circle. The above rotating large circle acts as a rotating shoulder sleeve, so that the two materials are mixed together; to load powder, open the inner sleeve large circle without contacting the material, so it is not susceptible to moisture. This solution is suitable for packaging lyophilized powder products.

The pump mouth at the pump body of the said pump core assembly is fastened and attached to the upper catch groove located in the middle of the top section of the inner sleeve large circle. The lower catch ring of the bottom groove of the inner sleeve large circle is fastened and attached to the inner catch ring of the top groove of the rotating large circle. The pump core assembly is disposed within the pump core cavity hermetically formed by the inner sleeve large circle, the rotating large circle, and the fixed large circle.

An inner wall circle is disposed on the inner diameter where the inner sleeve large circle is fastened and attached to the rotating large circle, the ring mouth on the bottom of the inner sleeve large circle is hermetically fastened and attached to outer ring groove between the inner diameter of the top ring mouth of the rotating large circle and the inner wall circle, and the outer ring mouth of the inner wall circle positioned lower than the inner ring mouth at the inner catch ring of the rotating large circle. The overflow of material from the upper storage cavity into the pump core compartment is prevented, thereby enhancing the sealing effectiveness of the upper storage cavity.

A head cap sleeve mouth that is smaller than the lower outer diameter and protruded is disposed in the middle of the top section of the inner sleeve large circle, the upper catch groove of the inner sleeve large circle is provided on the bottom of the inner diameter of the head cap sleeve mouth, the cover latch rib of the inner sleeve large circle and the upper storage cavity at the head cap sleeve mouth protrude upwardly, the bottom cap latch of the head cap is inserted into the head cap sleeve mouth of the inner sleeve large circle, and a nozzle with an outwardly protruded outer diameter disposed at the liquid outlet of the head cap. The above structure further increases the space and volume of the upper storage cavity and prevents the inflow of overflowing liquid from the head cap.

A cover latch rib is provided above the point where the said inner sleeve large circle is fastened to the rotating large circle and that is smaller than the outer diameter of the bottom ring mouth, the mouth of the outer cover is fastened and attached to the cover latch rib of the inner sleeve large circle. The specific position where the outer cover is fastened to the inner sleeve large circle is described above. Alternatively, it can be fastened to the outer diameter and other position disposed on the rotating large circle.

A funnel-shaped bottom face that is intensively sinking towards the upper thru-hole of the rotating large circle is disposed on the bottom of the upper storage cavity of the top groove of the said rotating large circle. The above structure facilitates the total discharge or fall of the material in the upper storage compartment.

The sealing plug has notches on the outer diameter of its edge and on the inner diameter of the central hole respectively. The large rotating ring has a locating column protruded on the bottom of the large rotating ring corresponding to the notch. The sealing plug is joined to the bottom of the rotating large circle, and a protruded sealing rib is provide at the bottom hole mouth of the middle thru-hole of the sealing plug. The above structure makes it easier for the sealing plug to be secured to the bottom of the rotating large circle, or alternatively, it can be also secured by plastic screws, end snap fasteners and other methods.

An upwardly protruded circle latch is symmetrically disposed on the ring mouth of the fixed large circle where the said fixed large circle is attached to the rotating large circle, and raised pieces that are equidistantly distributed are provided in the top ring groove at the attached point where the ring latch corresponds to the rotating large circle. Thus, it is convenient for the rotating large circle to generate resistance and sound when rotating, and realize opening and closing by combining with the logo, i.e., the above-mentioned snap point design prevents liquid leakage from the open compartment when rotating back during transit.

A downwardly protruded funnel nozzle is disposed in the center of the pump core assembly of the said fixed large circle, the liquid inlet hole at the bottom of the pump body of the pump core assembly aligns with the funnel nozzle of the fixed large circle, or the suction pipe hole at the bottom of the pump core assembly is inserted into the funnel nozzle of the fixed large circle.

The said bottle comprises an inner bottle and an outer bottle. The vent hole is located on the bottom side of the inner bottle, and the bottle body is fastened and attached to the fixed large circle through the mouth of the inner bottle, and the inner bottle, the fixed large circle, the rotating large circle, the inner sleeve large circle (8), the pump core assembly, and the head cap are connected sequentially to form a replacement bottle. After the upper storage compartment of the replacement bottle is filled, the inner bottle is filled and assembled with the outer bottle for use.

Fastening holes are symmetrically located on the mouth of the said outer bottle. Lead-in grooves are provided on the inner diameter side of the outer bottle mouth corresponding to the fastening holes respectively. Protruded fixing ribs are provided on the lower outer diameter where the inner bottle is fastened to the rotating large circle respectively. The inner body is inserted to the lead-in groove of the outer bottle through the fixing ribs, then revolvably secured to the fastening hole of the inner bottle, and the inner body engages with the outer bottle.

The outer diameters of the said rotating large circle and the fixing large circle are respectively provided with a toothed ring that is easy to grip and rotate.

The present invention has reasonable structural design, easy to use and carry, good sealing and stability, good moisture-proof effect, and is suitable for reuse and assembly as a replacement bottle; it is mainly used as a double-compartment fresh-keeping vacuum bottle for powder storage, and the structural modification of its similar products.

### BRIEF DESCRIPTION OF ACCOMPANYING DRAWINGS

FIG. 1 is a schematic diagram of an exploded structure of the first embodiment of the present invention.

FIG. 2 is a schematic diagram of the replacement bottle structure of FIG. 1, with the dotted line showing the inner structure of the outer cover.

FIG. 3 is a schematic diagram of the bottom structure of the head cap assembly of FIG. 2.

FIG. 4 is a schematic diagram of the bottle assembly structure of FIG. 2 with the addition of the outer bottle.

FIG. 5 is a schematic structural diagram of FIG. 2 in use with the addition of the outer bottle.

FIG. 6 is a schematic diagram of the sectional structure of FIG. 5.

FIG. 7 is a schematic diagram of the three-dimensional structure of the second embodiment of the present invention.

FIG. 8 is a schematic diagram of the sectional structure of FIG. 7. FIG. 9 is a schematic diagram of the exploded structure of FIG. 7.

Serial numbers and names of the accompanying drawings: 1. Outer bottle, 101. Fastening hole, 102. Lead-in groove, 2. Inner body, 201. Fixing rib, 3. Piston, 4. Gasket, 5. Fixing large circle, 501. Lower thru-hole, 502. Circle latch, 503. Funnel nozzle, 6. Sealing plug, 601. Middle thru-hole, 7. Rotating large circle, 701. Upper thru-hole, 702. Inner catch circle, 703. Inner wall circle, 704. Locating column, 705. Raised piece, 8. Inner sleeve large circle, 801. Upper catch groove, 802. Lower catch groove, 803. Head cap sleeve mouth, 804. Cover latch rib, 9. Pump core assembly, 10. Nozzle, 11. Head cap, 12. Outer cover, 13. Replacement bottle, 14. Upper storage compartment, 15. Lower storage compartment.

### EMBODIMENTS

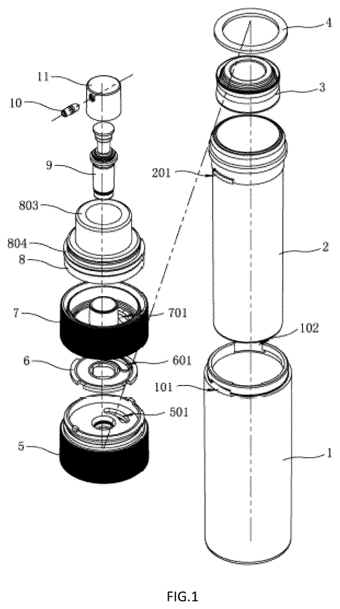

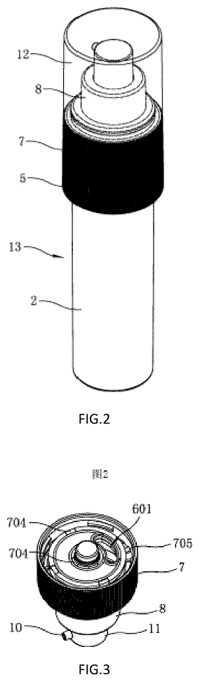

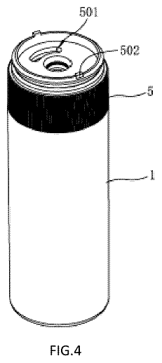

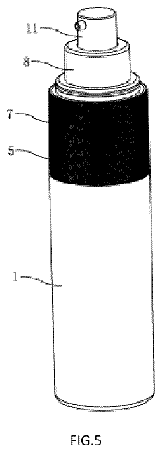

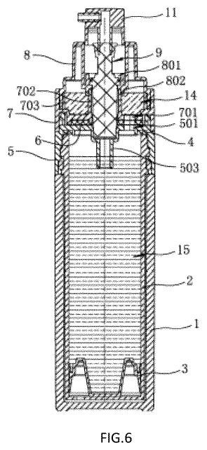

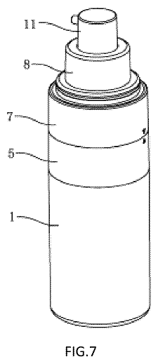

The structure of the present invention is further described in conjunction with the accompanying drawings. As shown in FIGS. 1-6, in Embodiment 1, the vacuum bottle comprises an inner bottle 2 and an outer bottle 1, a piston 3 is provided in the inner bottle, the vent hole is located on the bottom side of the inner bottle, and the bottle body is fastened and attached to the fixed large circle 5 through the mouth of the inner bottle, a gasket 4 is provided at the joint, the inner bottle, the fixed large circle, the rotating large circle 7, the inner sleeve large circle 8, the pump core assembly 9, and the head cap 11 are connected sequentially to form a replacement bottle 13. The mouth of the bottle body is connected to a large circle through snap fitting, thus creating a lower liquid storage cavity 15. The valve stem of the pump core assembly extends out in a large circle and is connected to the head cap; the large circle comprises a fixed large circle, a rotating large circle, and an inner sleeve large circle. A lower thru-hole 501 is provided on the side of the fixed large circle at the mouth above the lower liquid storage cavity 15 in the bottle body, an upper thru-hole 701 is provided on the side of the rotating large circle corresponding to the lower thru-hole; a sealing plug 6 is disposed on the fitting face where the rotating large circle is fastened and attached to the fixed large circle, the said sealing plug is affixed to the bottom of the rotating large circle, the middle thru-hole 601 of the sealing plug aligns with the upper thru-hole of the rotating large circle. The circle rim at the bottom of the inner sleeve large circle is fastened and attached to the circle rim inner diameter on the top of the rotating large circle. The pump core assembly is fastened and attached to the inner sleeve large circle, the pump body outer diameter of the pump core assembly is hermetically fit to the fixed large circle, rotating large circle, and inner sleeve large circle. The said upper liquid storage cavity is formed between the top groove of the rotating large circle and the bottom groove of the inner sleeve large circle. When the rotating large circle drives the sealing plug to rotate towards a certain position, making the upper thru-hole of the rotating large circle, the middle thru-hole of the sealing plug, and the lower thru-hole of the fixed large circle aligned sequentially, the material stored in the upper storage cavity falls into the bottle body until it mixes with the liquid stored in the body.

The pump mouth at the pump body of the said pump core assembly is fastened and attached to the upper catch groove 801, the lower catch ring 802 of the bottom groove of the inner sleeve large circle is fastened and attached to the inner catch ring 702 of the top groove of the rotating large circle. The pump core assembly is disposed within the pump core cavity hermetically formed by the inner sleeve large circle, the rotating large circle, and the fixed large circle. An inner wall circle 703 is disposed on the inner diameter where the inner sleeve large circle is fastened and attached to the rotating large circle, the ring mouth on the bottom of the inner sleeve large circle is hermetically fastened and attached to outer ring groove between the inner diameter of the top ring mouth of the rotating large circle and the inner wall circle, and the outer ring mouth of the inner wall circle positioned lower than the inner ring mouth at the inner catch ring of the rotating large circle. A head cap sleeve mouth 803 that is smaller than the lower outer diameter and protruded is disposed in the middle of the top section of the inner sleeve large circle, the upper catch groove of the inner sleeve large circle is provided on the bottom of the inner diameter of the head cap sleeve mouth, the cover latch rib of the inner sleeve large circle and the upper storage cavity at the head cap sleeve mouth protrude upwardly, the bottom cap latch of the head cap is inserted into the head cap sleeve mouth of the inner sleeve large circle, and a nozzle 10 with an outwardly protruded outer diameter disposed at the liquid outlet of the head cap. A cover latch rib 804 is provided above the point where the said inner sleeve large circle is fastened to the rotating large circle and that is smaller than the outer diameter of the bottom ring mouth, the mouth of the outer cover is fastened and attached to the cover latch rib of the inner sleeve large circle. A funnel-shaped bottom face that is intensively sinking towards the upper thru-hole of the rotating large circle is disposed on the bottom of the upper storage cavity (14) of the top groove of the said rotating large circle.

The said sealing plug has notches on the outer diameter of its edge and on the inner diameter of the central hole respectively. The large rotating ring has a locating column 704 protruded on the bottom of the large rotating ring corresponding to the notch. The sealing plug is joined to the bottom of the rotating large circle, and a protruded sealing rib is provide at the bottom hole mouth of the middle thru-hole of the sealing plug. An upwardly protruded circle latch 502 is symmetrically disposed on the ring mouth of the fixed large circle where the said fixed large circle is attached to the rotating large circle, and raised pieces 705 that are equidistantly distributed are provided in the top ring groove at the attached point where the ring latch corresponds to the rotating large circle. A downwardly protruded funnel nozzle 503 is disposed in the center of the pump core assembly of the said fixed large circle, the liquid inlet hole at the bottom of the pump body of the pump core assembly aligns with the funnel nozzle of the fixed large circle. Fastening holes 101 are symmetrically located on the mouth of the said outer bottle. Lead-in grooves 102 are provided on the inner diameter side of the outer bottle mouth corresponding to the fastening holes respectively. Protruded fixing ribs 201 are provided on the lower outer diameter where the inner bottle is fastened to the rotating large circle respectively. The inner body is inserted to the lead-in groove of the outer bottle through the fixing ribs, then revolvably secured to the fastening hole of the inner bottle, and the inner body engages with the outer bottle.

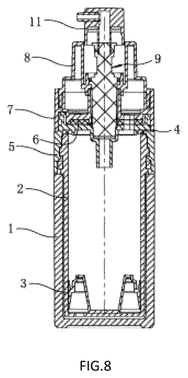

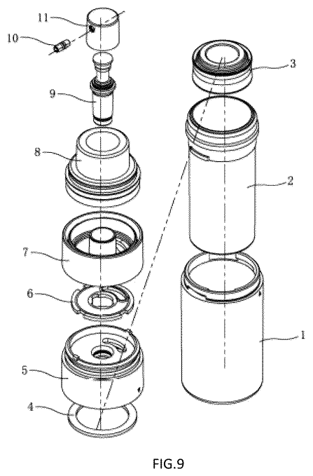

As shown in FIGS. 7-9, in Embodiment 2, the rotating and fixing rings of Embodiment 1 are respectively provided with a toothed rings on the outer diameter to facilitate holding and rotation, and the above toothed rings are omitted in Embodiment 2, and the height of the bottle in Embodiment 2 is lower than that of Embodiment 1.

Before use, according to the rotating large circle and the fixed large circle of the logo prompts, rotate the large circle, open the head cap assembly, the fixed large circle to add the packaging of lyophilized powder products, the head cap assembly of the rotating large circle and the fixed large circle to re-fix the fastening; and then, open the bottle body, the bottle body of the inner bottle to add the liquid, the vacuum bottle is ready for use. When in use, turn the rotating circle, the powder product in the rotating ring falls into the liquid stored in the inner bottle, shake the vacuum bottle, and the vacuum bottle is ready for use.

In summary, the vacuum bottle is a form of packaging for cosmetic products, which is mainly used to hold the ingredients of cosmetic products unaffected by the external environment, in order to prolong their freshness and maintain the quality and effectiveness of the products, so as to maintain the stability of the ingredients, provide better sealing performance, and enhance the user experience. The vacuum bottle comprises of two parts: an inner bottle, which is a small airtight container that holds the cosmetic ingredients, and an outer bottle, which is an outer container that protects the inner flask and provides additional sealing and stability. During the manufacturing process, the inner bottle is placed inside the outer bottle and the air between the two is extracted through a special process and sealing technology, creating a vacuum environment; this vacuum prevents air, moisture and other harmful substances, thereby minimizing oxidation, bacterial growth, and other factors that could compromise the cosmetic ingredients.

1-10. (canceled)

11. A fresh-keeping vacuum bottle with two compartments, comprising a piston inside the bottle body, a vent hole disposed on the bottom side of the bottle body; the mouth of the bottle body is connected to a large circle through snap fitting, thus creating a lower liquid storage cavity; the liquid compartment is connected to the head cap through the valve stem of the pump core assembly, in which the valve stem extends out in a large circle; wherein the large circle comprises a fixed large circle, a rotating large circle, and an inner sleeve large circle; the fixed large circle is attached to the mouth of the bottle body through snap fitting, a gasket is provided at the joint, a lower thru-hole is provided on the side of the fixed large circle at the mouth above the lower liquid storage cavity in the bottle body, an upper thru-hole is provided on the side of the rotating large circle corresponding to the lower thru-hole; a sealing plug is disposed on the fitting face where the rotating large circle is fastened and attached to the fixed large circle, the sealing plug is affixed to the bottom of the rotating large circle, the middle thru-hole of the sealing plug aligns with the upper thru-hole of the rotating large circle; the circle rim at the bottom of the inner sleeve large circle is fastened and attached to the circle rim inner diameter on the top of the rotating large circle; the pump core assembly is fastened and attached to the large circle of the inner sleeve large circle or the rotating large circle, with the pump body outer diameter hermetically fit to the fixed large circle, rotating large circle, and inner sleeve large circle; an upper liquid storage cavity is formed between the top groove of the rotating large circle and the bottom groove of the inner sleeve large circle; when the rotating large circle drives the sealing plug to rotate towards a certain position, making the upper thru-hole of the rotating large circle, the middle thru-hole of the sealing plug, and the lower thru-hole of the fixed large circle aligned sequentially, the material stored in the upper storage cavity falls into the bottle body until it mixes with the liquid stored in the body.

12. The fresh-keeping vacuum bottle with two compartments as described in claim 11, wherein the pump mouth at the pump body of the pump core assembly is fastened and attached to the upper catch groove located in the middle of the top section of the inner sleeve large circle; the lower catch ring of the bottom groove of the inner sleeve large circle is fastened and attached to the inner catch ring of the top groove of the rotating large circle; the pump core assembly is disposed within the pump core cavity hermetically formed by the inner sleeve large circle, the rotating large circle, and the fixed large circle.

13. The fresh-keeping vacuum bottle with two compartments as described in claim 11, wherein an inner wall circle is disposed on the inner diameter where the inner sleeve large circle is fastened and attached to the rotating large circle, the ring mouth on the bottom of the inner sleeve large circle is hermetically fastened and attached to outer ring groove between the inner diameter of the top ring mouth of the rotating large circle and the inner wall circle, and the outer ring mouth of the inner wall circle positioned lower than the inner ring mouth at the inner catch ring of the rotating large circle.

14. The fresh-keeping vacuum bottle with two compartments as described in claim 11, wherein a head cap sleeve mouth that is smaller than the lower outer diameter and protruded is disposed in the middle of the top section of the inner sleeve large circle, the upper catch groove of the inner sleeve large circle is provided on the bottom of the inner diameter of the head cap sleeve mouth, the cover latch rib of the inner sleeve large circle and the upper storage cavity at the head cap sleeve mouth protrude upwardly, the bottom cap latch of the head cap is inserted into the head cap sleeve mouth of the inner sleeve large circle, and a nozzle with an outwardly protruded outer diameter disposed at the liquid outlet of the head cap.

15. The fresh-keeping vacuum bottle with two compartments as described in claim 11, wherein a bottom cap latch is disposed on above the point where the inner sleeve large circle is fastened and attached to the rotating large circle that is smaller than the outer diameter of the bottom ring mouth, the cover mouth of the outer cover is fastened and attached to the cover latch rib of the inner sleeve large circle.

16. The fresh-keeping vacuum bottle with two compartments as described in claim 11, wherein a funnel-shaped bottom face that is intensively sinking towards the upper thru-hole of the rotating large circle is disposed on the bottom of the upper storage cavity of the top groove of the rotating large circle.

17. The fresh-keeping vacuum bottle with two compartments as described in claim 11, wherein the sealing plug has notches on the outer diameter of its edge and on the inner diameter of the central hole respectively, the large rotating ring has a locating column protruded on the bottom of the large rotating ring corresponding to the notch; the sealing plug is joined to the bottom of the rotating large circle, and a protruded sealing rib is provide at the bottom hole mouth of the middle thru-hole of the sealing plug.

18. The fresh-keeping vacuum bottle with two compartments as described in claim 11, wherein an upwardly protruded circle latch is symmetrically disposed on the ring mouth of the fixed large circle where the fixed large circle is attached to the rotating large circle, and raised pieces that are equidistantly distributed are provided in the top ring groove at the attached point where the ring latch corresponds to the rotating large circle.

19. The fresh-keeping vacuum bottle with two compartments as described in claim 11, wherein the bottle comprises an inner bottle and an outer bottle; the vent hole is located on the bottom side of the inner bottle, and the bottle body is fastened and attached to the fixed large circle through the mouth of the inner bottle, and the inner bottle, the fixed large circle, the rotating large circle, the inner sleeve large circle, the pump core assembly, and the head cap are connected sequentially to form a replacement bottle.

20. The fresh-keeping vacuum bottle with two compartments as described in claim 19, wherein fastening holes are symmetrically located on the mouth of the outer bottle; lead-in grooves are provided on the inner diameter side of the outer bottle mouth corresponding to the fastening holes, respectively; protruded fixing ribs are provided on the lower outer diameter where the inner bottle is fastened to the rotating large circle, respectively; the body is inserted to the lead-in groove of the outer bottle through the fixing ribs, then revolvably secured to the fastening hole of the inner bottle, and the inner body engages with the outer bottle.
